(19) United States
(12) Patent Application Publication
(10) Pub. No.: US 2005/0181722 A1
(43) Pub. Date: Aug. 18, 2005

(54) Method, system and user terminal for collecting information on audience of broadcast media stream

(76) Inventors: Toni Kopra, Vantaa (FI); Mikko Makipaa, Helsinki (FI); Akseli Anttila, Helsinki (FI)

Correspondence Address: CRAWFORD MAUNU PLLC, 1270 NORTHLAND DRIVE, SUITE 390, ST. PAUL, MN, 55120, US

(21) Appl. No.: 10/511,767

(22) PCT Filed: Apr. 14, 2003
(86) PCT No.: PCT/FI03/00288

Related U.S. Application Data
(63) Continuation-in-part of application No. 10/126,623, filed on Apr. 22, 2002.
(63) Continuation-in-part of application No. 10/319,475, filed on Dec. 16, 2002.

(51) Int. Cl. H04H 9/00

(52) U.S. Cl. 455/2.01

(57) ABSTRACT

The invention is related to a method for collecting information on an audience of a broadcast media stream. The method comprising: broadcasting a media stream on at least one broadcast channel of the broadcast system, transmitting parallel information on at least one parallel channel which parallel information is associated and synchronized with the media stream of at least one broadcast channel, connecting the audience to the media system as passive users or active users, the active users receiving the parallel information and the passive users not receiving the parallel information, collecting information on the audience connected to the media system, the information being on active users and/or passive users, processing the collected information in a predetermined way.

### FILED

The invention relates to a method, a system and a user terminal for collecting information on the audience of a broadcast media stream.

### BACKGROUND

Many broadcasters are interested in monitoring their audience for several reasons. Especially commercial radio or television broadcasters need customer information for improving their business: the more they have listeners the more tempting they are from an advertiser's point of view. Advertisers also need information on their campaigns: how many customers listened to an advertisement, whether they liked it or not, how well the product sold, etc.

In the prior art there are several research methods for collecting information on audience. Some widely used methods are questionnaires or focus group interviews. These methods are quite slow and they cannot be used in online adaptation of the broadcast. Additionally, questionnaires or group interviews are directed to a selected audience group, the size of which is limited. Therefore the reliability of the results depends strongly on advance planning and the size of the group, since the size of the group has to be quite significant in order that the result is reliable, the expenses rise correspondingly.

Especially, the prior art methods are not rapid enough in monitoring the audience of interactive programs which nowadays are becoming more and more popular.

### BRIEF DESCRIPTION OF THE INVENTION

An object of the invention is to provide an improved method for collecting information on an audience of a broadcast media stream. The method comprising: connecting a radio telecommunication system and a broadcast system to perform a media system, broadcasting a media stream on at least one broadcast channel of the broadcast system, transmitting parallel information on at least one parallel channel which parallel information is associated and synchronized with the media stream of at least one broadcast channel, connecting the audience to the media system as passive users or active users, the active users receiving the parallel information and the passive users not receiving the parallel information, collecting information on the audience connected to the media system, the information being on active users and/or passive users, processing the collected information in a predetermined way.

According to an aspect of the invention, there is provided a media system for collecting information on the audience of a broadcast media stream, comprising: means for broadcasting a media stream on at least one broadcast channel of the broadcast system, the broadcast system being part of the media system, transmitting parallel information on at least one parallel channel which parallel information is associated and synchronized with the media stream of at least one broadcasting channel using a radio telecommunication system of the media system, means for connecting the audience to the media system as passive users or active users, the active users receiving the parallel information and the passive users not receiving the parallel information, means for collecting information on the audience connected to the media system, the information relating to active users and/or passive users, means for processing the collected information in a predetermined way.

According to another aspect of the invention, there is provided a user terminal for collecting information on an audience of a media stream broadcast by a media system comprising: means for receiving parallel information on at least one parallel channel which parallel information is associated and synchronized with the media stream of at least one broadcast channel of the broadcast system, the broadcast system being a part of the media system, means for connecting the audience to the media system as passive users or active users, the active users receiving the parallel information and the passive users not receiving the parallel information, means for changing a parallel information reception state according to the user's selections, means for transmitting selections made by active users for collecting information on the audience connected to the media system, means for showing the collected information.

Further embodiments of the invention are described in the dependent claims.

The method and system of the invention provide several advantages. According to an embodiment of the invention, the radio station is able to observe the development of an on-line audience almost real time, obtain viewable statistical information on the audience and arrange interactive polls, competitions, etc.

### LIST OF DRAWINGS

In the following, the invention will be described in greater detail with reference to the preferred embodiments and the accompanying drawings, in which

FIG. 1 shows an example of a wireless telecommunication system,

FIG. 2 is an example of a media system,

FIG. 3 is a flow chart,

FIGS. 4A-C show an example of a broadcast system, a server and a content creation tool,

FIG. 5 shows an example of a user terminal.

### DESCRIPTION OF EMBODIMENTS

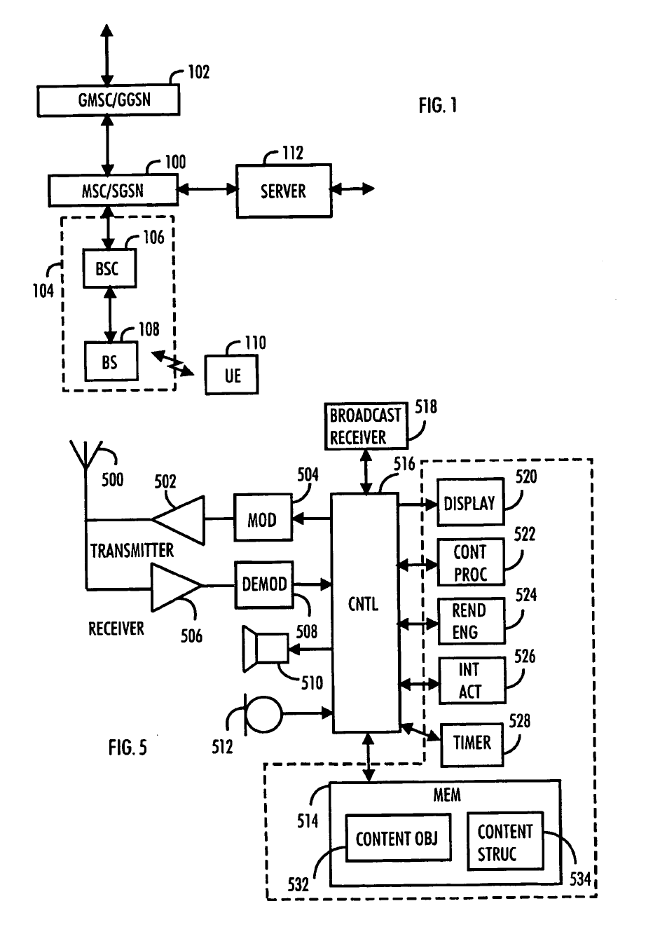

Referring to FIG. 1, a block diagram illustrates an example of a wireless telecommunication system. The wireless telecommunication system may be based on, for example, UMTS (Universal Mobile Telephone System) or WCDMA (Wideband Code Division Multiple Access).

The core network may correspond to a combined structure of the GSM (Global System for Mobile Communications) and GPRS systems (General Packet Radio Service), for example. The GSM network elements are responsible for the implementation of circuit-switched connections, and the GPRS network elements for the implementation of packet-switched connections, some of the network elements, however, being shared by both systems.

A centre 100 represents a mobile services switching centre (MSC) and a serving GPRS support node (SGSN) enabling circuit-switched and packet switched signalling, respectively, in the radio system.

The core network may have a gateway unit 102, which represents a gateway mobile service switching centre (GMSC) and a gateway GPRS support node. The GMSC attends to the circuit-switched connections between the core network and external networks, such as a public land mobile network (PLMN) or a public switched telephone network (PSTN), and the GGSN attends to the packet-switched connections between the core network and external networks such as the Internet.

The centre 100 controls a radio access network (RAN) 104, which may comprise at least one base station controller 106 controlling at least one base station 108. The base station controller 106 may also be called a radio network controller and the base station may be called a node B. A subscriber terminal 110 communicates with at least one base station 108 over a radio interface.

The radio server 112, which is an important part of the present solution, may be connected to the centre 100, but it may also be connected to the gateway 102 or to some part of the RAN 104. In some applications, the radio server 112 may communicate with the radio system over a radio interface in the same manner as the subscriber terminal 110.

Telecommunication systems are explained in further detail in the standards and literature of the field.

FIG. 2 shows an example of an embodiment of how a wireless telecommunication system and a broadcasting system are connected together for performing a media system for transmitting parallel information related to a broadcast media stream, such as a radio program. Regarding the parallel channel, the media system may comprise the following elements: a broadcast system 200, a content creation tool 202, a server 112, the network 104 of a wireless telecommunication system and the subscriber terminal 110. The broadcast system 200 of a broadcast station uses a digital content management system to run a broadcast, such as an FM transmission, an AM transmission or a digital radio or television transmission. The broadcast system 200 broadcasts TV or radio programs.

The content creation tool 202, which may also be called a visual radio tool, is used to create parallel channel content presentation to be displayed on subscriber terminals. The content creation tool 202 typically locates in the radio or television station and it may be integrated into the broadcast system 200.

The server 112 provides the users with the content related to the broadcast based on their current parallel channel selection. The server 112 controls the content flow to and from the subscriber terminals. It facilitates a timed delivery of the content to the subscriber terminal, as well as the collecting and forwarding of interaction results to the radio station. The server controls the number of users. If necessary, the server limits the number of users using the parallel channel at the same time. The server also takes care of content adaptation for different application platforms in various subscriber terminals.

A radio access network (RAN) 104 provides the connection to the subscriber terminals via a wireless telecommunication network. The subscriber terminal may be a mobile phone, a palm computer or a laptop, for instance. The details of the radio access network and subscriber terminals may vary according to the manufacturer and the used wireless telecommunication standard applied.

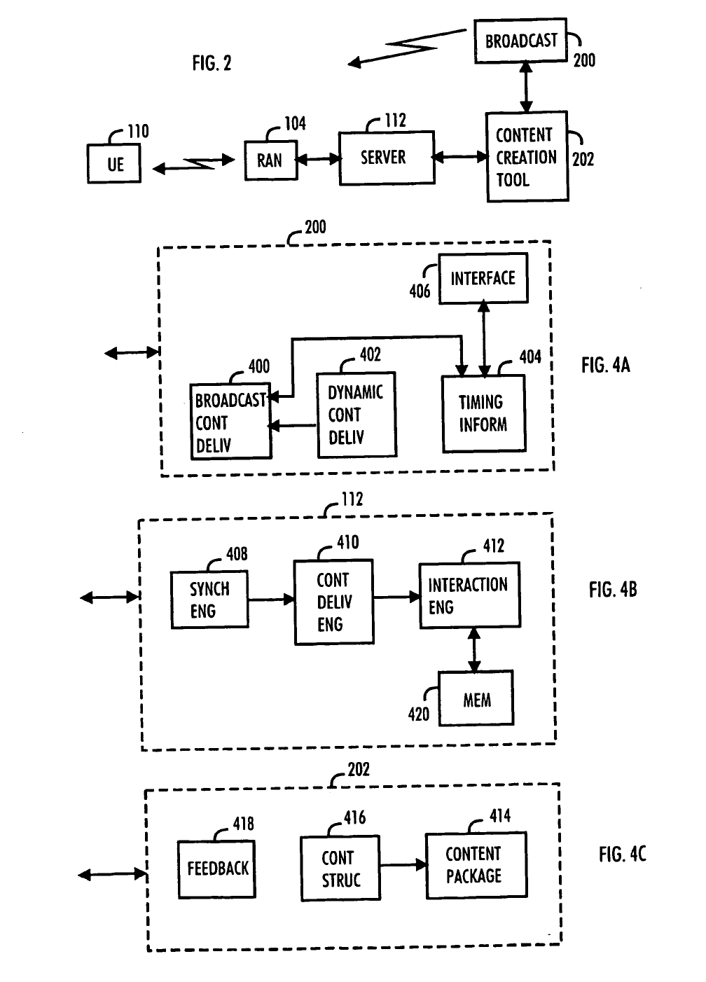

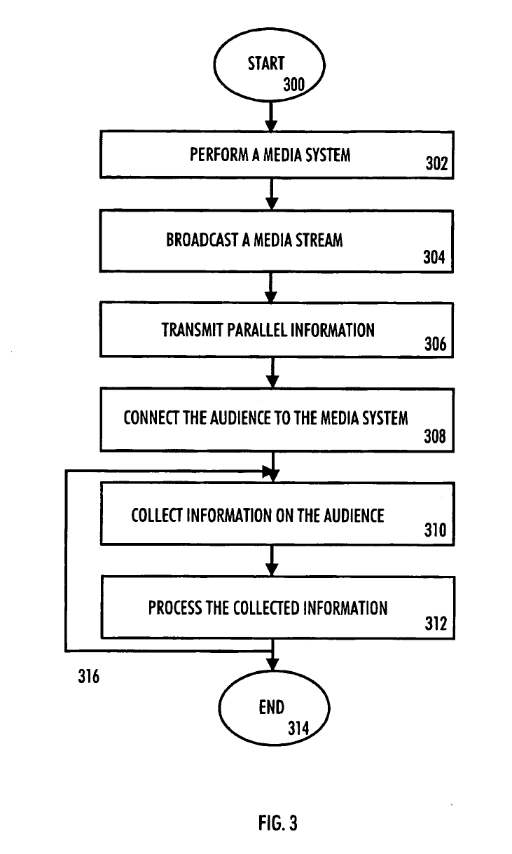

FIG. 3 is a flow chart depicting a preferred embodiment of a method for collecting information on the audience of a broadcast media stream. An embodiment of the method uses a visual radio application in the subscriber terminal, a visual radio server and a content creation tool, which will be discussed later in this application. The method is suitable for obtaining information on the audience of a radio or TV program for example to poll audience opinions in relation to a broadcast (programs or advertisements), to create interactive advertising and other interactive events, such as voting and quizzes, or to keep record of the number of the audience in general. The radio station is able to observe the development of an on-line audience almost real time, obtain statistical information on the audience and arrange interactive polls, competitions, etc.

The method begins in block 300. In block 302 a telecommunication system and a broadcasting system are connected together for performing a media system for transmitting parallel information related to a broadcast media stream. The media system is depicted in more detail in FIGS. 2 and 4A-C. The parallel information (also called the parallel channel content) typically comprises one or more parallel information objects (text strings, graphic file objects, animations, video clips, etc) and instructions for displaying the objects (positions of objects, timing, etc.).

In block 304 a media stream is broadcast on at least one broadcast channel of the broadcast system. Nowadays, the broadcast system of a broadcast station typically uses a digital content management system to run a broadcast, such as an FM transmission, an AM transmission, or a digital radio or television transmission. Programs including advertisements and breaks for ad hoc presentations are stored beforehand and the digital content management system runs the programs under the control of an editor.

In block 306 parallel information which is associated and synchronized with the media stream of at least one broadcast channel is transmitted using the media system. The parallel information is transmitted on a parallel channel. There may also be several parallel channels. The process regarding the creating and transmitting of the parallel information will be discussed in further detail later in this application. Briefly, the parallel information is created using the broadcast system, the content creation tool and the visual radio server and then sent to the user via a radio telecommunication network. The parallel information is usually transmitted as a packet transmission.

In block 308 the audience is connected to the media system either as passive users or active users, the active users receiving the parallel information and the passive users not receiving the parallel information. In other words, the term active refers to users who are actively receiving the content updates delivered by the radio server, i.e. these users are in a flow mode. Passive users are users who are not receiving the content updates, and may or may not be using the service at a particular moment. The audience has preferably an interactive connection to the media stream system via an interactive menu shown on the screen of their user terminals. The users who have the terminal application running, and are viewing the (delivered parallel channel) content on the screen are active users. The users who have the application running but do not receive the content are passive. A user might not receive/see the content due to multiple reasons: the application is minimized or run in a background, another application is running on the screen foreground and application has no display screen, screen saver is on, the application is running but a user is doing something else which prevents him seeing the parallel channel (i.e. browsing some other content). The application should report changes in the state to the server.

In block 310 information on the audience connected to the media system is collected. This is done by using the parallel channel as a feedback channel. If the system comprises several parallel channels, it is possible to use one channel as a forward channel and another as a feedback channel, for instance. The information may relate to active users and/or passive users. The state of parallel information reception (active or passive) of a user terminal is reported to the server to provide on-line information on the number of active and/or passive users. The server collects the information and maintains a database of the statistics. In addition, the information may relate to polling audience opinions in relation to broadcasts (programs or advertisements). Information may be collected from advertising, votes and quizzes, etc. For interactive advertising, the number of responses received from the audience is collected.

The templates for the screen menu of a subscriber terminal may be ready-made, in which case they are stored in a user terminal and modified according to the parallel information. The templates may also be transmitted as parallel information.

In an embodiment of the method, the subscriber terminal reports to the radio server when the application mode, that is the parallel information reception state, changes. Only users in the flow mode (active users) are assumed to be able to view the current content, whereas other (passive users) may be listening to the broadcast but are not actively following the information on the parallel channel. When a user is in the flow mode, content delivered from the server is updated automatically on the terminal screen according to the timing definition. The application may be switched to the background or to the initiating communication off-mode or a screen saver may be turned on, preventing the user from viewing the current content updates. These users are called passive users.

The events to be reported to the server are, for instance: an application start, i.e. a currently selected radio station is reported to the server, an application end, i.e. a pause in the reception of a parallel channel and or a change of a mode of the application is reported (for instance from a pause state to a resume state), and an application poll, i.e. a response to a query sent by the server is reported. The server may also update its information periodically.

The visual radio application may be instructed to send a response to the server when the user starts an interactive connection by a pressing a virtual button on the screen. The response to be sent is defined separately for each button on the screen by the content creation tool. The timing of the chances in the general appearance of the screen may be defined to match a particular event in the broadcast, such as a song, an advertisement or a competition.

The subscriber terminal may have an identifier that is sent to the server with an event report. This dentifier may be a terminal-specific identifier or derived from one, e.g. IMSI or MSISDN, or created by the server as a response to a terminal request and stored by the terminal between sessions (similar to the cookie mechanism in the Internet). This makes it possible to obtain information on a particular subscriber terminal. An interactive event, such as a quiz, may also have an identifier that enables connecting answers to the corresponding interactive event and performing statistics.

In block 312 the collected information is processed in a predetermined way, for example statistically, The information may also be shown on the screen of a user terminal or a broadcaster's terminal. Templates for showing the collected information may be made and stored in a terminal in advance. The ready-made templates can be modified according to the parallel information. If the templates do not require too much transmission capacity, they can also be transmitted entirely as a parallel information.

In an embodiment, the server maintains a database for subscriber terminal event reports and uses the database to create graphics of statistical information, which are shown in a subscriber terminal using a content creation tool. The graphics may be automatically updated when new information becomes available or created as a response to a query. Many kinds of information views may be shown on the basis of events reported from subscriber terminals: the number of current users, current active users and current passive users. The number of current users is increased when an application start-message is reported and decreased when an application end-message is re-ported. The number of current active users is increased when an application start or an application resume-message is reported and decreased when an application pause or an application end-message is reported. The number of current passive users is increased when an application pause is reported and decreased when an application resume is reported. It should be noticed that application polling and periodic reporting can be used to refresh the numbers at any time.

When it comes to the interactive advertising, the number of responses received from the audience is collected. When an interactive screen containing different options is delivered to subscriber terminals, graphics and/or other corresponding information (options, images, etc.) are initialised. Each time an interactive response is reported from a subscriber terminal as a selection preformed by the user, the number of the option is increased in the database of the server. The share of the audience participating in the action in question can be given as a percentage of selected options compared with the number of active users, for instance. The information in the database of the server can be saved for later use to enable long-term analysis of the data.

A couple of examples of utilising the information gathered form the audience are: the collected information may be used for searching for good hours, geographical areas and/or modes for advertising; the best time to advertise is, of course, the time when the amount of the audience is biggest. The type of the audience is also important and this is why the user profiles are important. The geographical areas are interesting, when the advertiser wants to aim his advertising to a particular area, its neighbourhood, for instance. It is also possible to improve the mode of advertising by using polls.

Because each event reported from a subscriber terminal contains an identifier, it is possible to use the database for a statistical analysis. One example is the forming of listening profiles, for example the number of times a user returns to the station during a predetermined period of time.

If the user identifier is compared to demographic statistics or other comparable information on the user, the database can also be used for more specific analysis of user groups and segments in real time.

The method ends in block 314. An arrow 316 depicts one possibility for repeating the method.

It should be noticed that it is possible to collect location information on the audience. For this purpose, a user terminal may send information on its location or there may be a separate database comprising location information. By using location information it is possible to observe the amount of audience in a particular location.

Next, an example of an embodiment of the method for collecting information on the audience of a broadcast media stream is discussed. Although this embodiment is described with reference to a radio broadcast systems. The invention can be applied to other broadcast systems as well.

The transmitting of parallel information associated and synchronized with the media stream of at least one broadcasting channel comprises two main phases: creating parallel information and transmitting it.

The parallel information is created as follows: a radio station creates a parallel information definition message by using the content creation tool 202. The creating of the parallel information definition message requires information such as user options, a displayed prompt text, a screen layout, a parallel information identifier and timing information. The content creation tool 202 sends the parallel information definition message to the server 112. The server 112 searches for a corresponding parallel information object in the database. The server 112 transmits the parallel information object usually as a packet transmission to the connected terminals 110. The parallel information object is saved in the memory of a subscriber terminal 110 for later use, or it is shown immediately. The server 112 may modify the parallel information object by defining terminal-specific parameters, such as virtual button sizes and positioning on the screen of the subscriber terminal and/or graphics according to the requirement of the subscriber terminal in question. The parallel information is shown on the screen of the subscriber terminal in synchronization with the broadcast.

Information on active users is collected as follows: a user answers to a poll, quiz or the like, by selecting an option shown on the screen by pressing a virtual button. The answer, and together with it, the user identification and/or the parallel information identifier are communicated to the server 112.

The information can be processed in several ways. For example, the server 112 aggregates the number of the answers corresponding to the answer in question.

The content creation tool periodically inquiries the server to get updated statistics. The updated statistics are read from the database of the server 112 and sent to the content creation tool 202 which updates its display in such a way that the current situation can be seen. The content creation tool 202 is in this example the terminal of the broadcaster.

FIGS. 4A-B depict more details of the broadcast system, the server and the content creation tool. The shown functional structures are examples and it is obvious for a person skilled in the art that the broadcast systerm, the server and the content creation tool can be implemented in several ways.

The broadcast system is shown in FIG. 4A. The broadcast system 200 comprises a timing information module 404, a dynamic content delivery module 402 and a user interface 406. Timing information is used to synchronize transmissions of the broadcast channel and the parallel channel. It is communicated to the server 112 by the timing information module 404. The timing information module 404 provides information on the starting time and ending time of a particular program, as well as the timing of advertising breaks etc. The length of broadcast advertisements and similar breaks can be deduced, for example, from the show's run time at the starting time of the break.

The dynamic content delivery module 402 can feed additional content information to a content structure tool 416 and a content packaging module 414 included in the content creation tool 202 and, finally, to a content delivery engine 410 in the server 112. The additional content information from the dynamic content delivery module 402 can be, for example, results of events arranged in the broadcast, such as the name of a winner in a quiz show. When the additional content information is determined during the program, for example, during live events, a sports coverage or in a broadcast radio, the additional content information is communicated to the content packaging module 414 in the content creation tool to dynamically create additional content items of the parallel information.

In addition, the dynamic content delivery engine module 402 may receive interaction results from an interaction engine 412 located in the server 112 through a feedback module 418 in the content creation tool 202 and to be used as a part of the broadcast, for example to display the results of a vote on the TV as a video overlay.

A user interface 406 controls and adjusts by the broadcasting personnel the parallel channel timing with respect to the broadcast media stream. For example, signalling in the parallel channel may be paused and resumed to stop and resume the playing of the parallel channel. These control events are communicated through a synchronization engine 408 located in the server 112 to the subscriber terminal 110, which then adjusts parallel channel timing accordingly.

The broadcast content delivery module 400 supplies the broadcast to a broadcast receiver, such as an FM radio receiver, a TV set, or the like. The receiver may be situated in the subscriber terminal.

The feedback module 418 of the content creation tool 202, the interaction engine 412 and the memory 420 of the server 112 process the interaction results and create a suitable presentation to be shown to the broadcasting personnel or to the receivers of the broadcast.

The server is shown in FIG. 4B. The server 112 provides the users with content related to the broadcast based on their current parallel channel selection. The server controls the flow of the parallel information content to and from the subscriber terminal. It facilitates the synchronized delivery of content to the subscriber terminal as well as the collecting and forwarding of interaction results to the radio station. The server controls the number of users. If necessary, the server limits the number of users using the parallel channel at the same time. The server also takes care of content adaptation for different application platforms in various subscriber terminals.

To enable statistics on both currently active and passive users to be complied, the subscriber terminal 110 reports to the server 112 when the application mode, that is the parallel information reception state, changes. Only users in a flow mode (active users) are assumed to be able to view the current content, whereas other (passive users) may be listening to the broadcast but are not actively observing the parallel channel. When a user is in the flow mode, content delivered from the server is updated automatically on the terminal screen according to the timing definition. The application may be switched to the background, to the initiating communication off-mode or a screen saver may be activated, preventing the user from viewing the current content updates of the parallel information.

The synchronization engine 408 receives the starting time and the advertising break information from the timing information module 404 of the broadcast system 200. In addition, the synchronization engine 408 provides the means for subscriber terminals to synchronize their clocks with broadcast system time references by running a synchronization algorithm with the server.

The content delivery engine 410 delivers a signal with the content package created by the content packaging module 414 of the content creation tool to the content delivery engine 410 in the server. The signal is fed from the content delivery engine 410 to the interaction engine 412 in the server which sends the signal through the network 104 to the subscriber terminal 110 as parallel information. A subscriber-terminal-specific variant of the content can be delivered, which contains graphics objects optimised to the capabilities and the screen size of each subscriber terminal. A content package, including object identifications or other content items, may correspond to an entire program and be delivered before the program starts. The content can alternatively be delivered in a single package that contains both the subscriber terminal software module in a suitable format, such as a Java MIDlet and the content package for a particular show. This is suitable for recorded shows and programs, where the content and content timeline are known beforehand. In that case, dynamic content can be delivered in addition to the content package to take care of variation in the content during the broadcast.

Alternatively, the content can be delivered dynamically in content blocks, one block corresponding to a segment of a program. This approach is suitable for FM radio for example, where several songs to be played and different kinds of breaks such as advertising breaks are usually decided in advance.

If a user answers to a poll, for instance by selecting an option shown on the screen by pressing the virtual button in question, the user identification and/or the parallel information identifier are communicated together with the answer to the interaction engine 412 of the server. The server aggregates number of the answers relating to the poll. Therefore, the server also comprises a memory 420, where identifiers and answers are stored. A memory record may be composed of a parallel information identifier, typically a number, for associating answers with the corresponding poll, advertisement etc, and the number of selections of each option, for example, and/or the memory record may be composed of a user identifier for forming a user profile.

The content creation tool 202 may periodically request the server 112 to give updated statistics. The updated statistics are read from the database and sent to the content creation tool 202, which updates its display in such a way that the current situation can be seen by a broadcaster.

If the responses are in text format, the radio server saves the responses in text format. The content creation tool then receives the responses in the text format and they are shown on the display as such.

The server 112 maintains a database in a memory 420 for subscriber terminal event reports and uses the database to create graphics of statistical information, which are shown on a subscriber terminal (or on a broadcasters terminal using a content creation tool 202). The graphics can be updated tained automatically when new information becomes available or created in response to a query.

Because each event reported from a subscriber terminal contains an identifier, it is possible to use the database for analysing of user profiles, for example the number of times the user returns to the station during a predetermined period of time.

If the user identifier is compared to demographic statistics or other comparable information on the user, the database can also be used for a more specific analysis of user groups and segments in real time.

The content creation tool is shown in FIG. 4C. The content creation tool 202, which may also be called a visual radio tool in many applications, is used to create the parallel channel content (or a parallel information object) presentation to be displayed on the subscriber terminal. The content creation tool can be used to poll audience opinions relating to broadcasts (programs or advertisements), to create interactive advertising and other interactions, such as votes and quizzes. The content creation tool is also used to monitor the compiled statistics on the server and to create or modify the outer appearance of the display of a subscriber terminal. It is also used to create the content of the parallel channel for collecting user responses. The parallel channel acts as a feedback channel for user responses sent back from subscriber terminals.

The content creation tool is typically located in the radio or television station and the content creation tool may be integrated into the broadcast system 200. A content structure tool 416 creates timing for displaying parallel channel content associated with a broadcast media stream in time (for example, to show this parallel channel object on the screen of the subscriber terminal at 14:43:02 after the beginning of the program). Responses that are sent to the server 112 in response to the user interaction can be fed to the feedback module 418 located in the content creation tool.

The content structure tool 416 defines the layouts for displaying the parallel information objects, such as the sizes and positions of the objects on the screen of the subscriber terminal.

The content packaging module 414 is used to create a content package i.e. the format in which the parallel information is delivered to the subscriber terminal 110, including instructions for displaying the information (positions of objects, timing, etc.), as well as the content to be displayed, which usually consist of one or more parallel information objects (text strings, graphic file objects, animations, video clips, etc).

Generally, the content creation tool allows the radio station to create a visual presentation and manage the content flow shown on the screen of the subscriber terminal in synchronization with the broadcast. In addition, the content creation tool allows the station to manage interactive elements, such as delivery and purchase of objects, votings and quizzes.

Additionally, it is possible to utilise location information on the audience. This is typically done by compiling location information in the server which then communicates the information to the content creation tool. The content creation tool visualises by using a map the amount of the audience in a particular area, for instance. The information can be used for profiling the audience, designing advertising, for instance. The user terminal may send information on its location or there may be a separate database comprising location information. Typically, it is not required to follow a particular audience member but to see the amount of audience in a determined area.

FIG. 5 shows a simplified example of a subscriber terminal whereto the embodiment of the invention can be applied. The terminal may be a mobile telephone or a microcomputer, for example, without being restricted thereto.

In the subscriber terminal, the media system provides an integrated user experience, allowing the user to start both listening to a broadcast and receiving the content relating to the broadcast on the parallel channel. The operation of the media system is based on two channels, the broadcast channel and the parallel channel. The media system, on the other hand, provides a visual and interactive parallel channel functionality, such as receiving and displaying content objects and reporting user interactions to a server.

The terminal comprises an antenna 500 with which signals are both transmitted and received via a duplex filter. A terminal may also comprise a broadcast receiver 518 such as a TV or a radio tuner, a video streaming engine, etc. for receiving for example radio or TV programs, with which case there is a need for a broadcast receiver antenna. These antennas may be integrated or separate antennas.

The terminal further comprises a transmitter for a wireless telecommunication system 502, to amplify and transmit a modulated signal to the antenna, a modulator 504 modulating the carrier wave by a data signal comprising the desired information in accordance with a selected modulation method, a receiver 506 which amplifies the signal supplied from the antenna and down-converts the signal to a selected intermediate frequency or directly to base-band, and a demodulator 508 demodulating the received signal to enable a data signal to be separated from the carrier wave.

The subscriber terminal also comprises a controller block 516 comprising, for example, control and calculation means for controlling the operation of the different parts of the terminal, means for processing the speech of the user or the data generated by the user, such as a digital signal processing (DSP) processor comprising, for example, channel correction functions compensating for interference in the signal caused by the radio channel by utilising information on the channel obtained from a known training sequence, A/D converters converting an analogue signal into a digital one by sampling and quantizing the baseband signal, D/A converters converting a digital signal to an analogue one by a reverse method, filters at the receiver which filter frequencies outside a desired frequency band or, which in band-restricted systems restrict the band width of the output at the transmitter, and coding and decoding means for both channel and speech coding.

Furthermore, in spread-spectrum systems, such as WCDMA, the spectrum of the signal is spread at the transmitter by means of a pseudo-random spreading code over a wide band and despread at the receiver, in an attempt to increase channel capacity. The control block also comprises means for arranging the signal to be transmitted and the signalling information to conform to the air interface standard of the cellular radio system used.

The user interface of the terminal comprises a loudspeaker or an earpiece 510, a microphone 512, a display 520 and possibly a keypad and/or a joystick or a similar device. The user interface devices communicate with the control block.

The terminal also comprises several different memory elements that are shown as one functional block 514. The parallel information delivered to the subscriber terminal from the server interaction engine 412 may be stored in the local memory 514.

The content structures (the layouts and other display instructions for displaying the parallel information objects typically performed on a slide basis, where the slide means one screen of information in the subscriber terminal) are separated from the parallel information and saved to the content structure memory 834. The content structure also comprises possible templates. The content objects (for example, texts and figures to be shown on the screen), in other words the parallel information objects are also separated and saved to the content object memory 532. The separation and saving can be performed as a background process, whereby the required information is always available to a content processor 522 and a rendering engine 524 when needed. The rendering engine 524 forms visual and acoustic effects. Default information can also be stored in the local memory to be shown in case dynamic content cannot be delivered to the subscriber terminal in time.

The initiation of the parallel channel can be made in several ways. The user can select an operation which causes the subscriber terminal to receive and display the information from the parallel channel. If the subscriber terminal includes a receiver for the broadcast channel, the user can select a suitable broadcast channel and the subscriber terminal may automatically initiate the reception and display of the parallel channel, instead of manual initiation.

When a parallel channel software operation is initiated in the subscriber terminal, the subscriber terminal may transmit information about itself to the server 112 and the server informs the subscriber terminal of the media stream. With the information on the subscriber terminal, a specific variant of the content can be delivered, which contains graphics objects optimised to the capabilities and the screen size of each subscriber terminal.

A timer controller module 528 establishes a connection to the server. The timer controller module 528 runs a synchronization algorithm to synchronize an internal clock of the subscriber terminal with the time in the server. A simple synchronization algorithm can be used, based on calculating round trip delays of requests sent to the server from the subscriber terminal and calculating the difference between the subscriber terminal clock and the server clock. Once the subscriber terminal has performed the synchronization and the starting time of a program is known, media stream timeline references can be translated to corresponding of references in the internal clock of the subscriber terminal. The parallel information can be shown to the user in synchronization with the broadcast.

The timer controller 528 determines whether the program has already started and what is the current timeline position. If the program is running, the timer controller 528 can automatically find the correct content item in the parallel channel to be displayed in the display of the subscriber terminal.

Once the software of the subscriber terminal is activated and the subscriber terminal has received parallel information to be shown, the content processor 522 starts executing. The processor reads the content structure in the content structure memory 534 for determining the current content to be displayed and communicates the content structure to the rendering engine 524. Based on the content structure, the content processor 522 informs the timer controller 528 to trigger proceeding in the parallel channel according to the content structure. Then the content processor 522 is initiated again to display the next parallel information object (content item). The processor 522 reads another content structure in the content structure memory 532, determines the next parallel information object and possible layouts and sends them to the display 520.

The subscriber terminal sends an action report message to the server, when a change in the parallel information channel state is triggered or a user answers to a poll, etc. The events to be reported to the radio server are, for instance: an application start (active state), i.e. a currently selected radio station is reported to the server, an application end, i.e. an application pause is reported when the mode of application changes (active/passive), an application poll, i.e. a response to a query sent by the server is reported and a periodic reporting.

A signal having information on the action is communicated to the content processor 522. The action may be a report on a change in the parallel information reception state or on a user activity such as an answer to a quiz, for example. The content processor then analyses the action and triggers a transaction as defined by the content structure of the action. The user activity automatically triggers communication from the subscriber terminal 110 to the server 112 and thus the user does not need to know a long list of service numbers, service codes or identification strings. The signal of the user action is communicated from the content processor to the interaction engine 526 of the subscriber terminal, which transmits the signal through the network to the interacton engine 412 of the server using the parallel channel as a feedback channel.

A subscriber terminal may have an identifier that is sent to the server with an event report. This identifier can be a terminal-specific identifier or derived from one, e.g. IMSI or MSISDN, or created by the server in response to a terminal request and stored by the terminal between sessions (similar to the cookie mechanism in the Internet). This makes it possible to obtain information on a particular subscriber terminal. An interactive event, such as a quiz, may also have an identifier that enables connecting answers to the corresponding interactive event and compiling statistics.

Blocks 522, 524, 526 and 528 required for the parallel channel communication may be situated in a specific software module. This module can be implemented using an operating system, such as Symbian, or a programming environment, such as Java MIDP.

After the parallel channel software module in the terminal is initiated, the module is informed of the broadcast and/or the program the user is interested to follow. The user can also make the selection by using another terminal software module, such as a program guide delivered to the terminal over a browser interface.

Even though the invention is described above with reference to an example according to the accompanying drawings, it is clear that the invention is not restricted thereto but it can be modified in several ways within the scope of the appended claims.

1. A method for collecting information on an audience of a broadcast media stream, the method comprising:
connecting a radio telecommunication system and a broadcast system to perform a media system,
broadcasting a media stream on at least one broadcast channel of the broadcast system,
transmitting parallel information on at least one parallel channel which parallel information is associated and synchronized with the media stream of at least one broadcast channel,
connecting the audience to the media system as passive users or active users, the active users receiving the parallel information and the passive users not receiving the parallel information,
collecting information on the audience connected to the media system, the information being on active users and passive users, and
processing the collected information in a predetermined way.

2. The method of claim 1, wherein the audience has an interactive connection to the media stream system via an interactive menu shown on the screen of a user terminal.

3. The method of claim 1, wherein the information on the audience is collected in a memory.

4. The method of claim 1, wherein the collected information is shown on the screen of a user terminal and a broadcaster's terminal.

5. The method of claim 1, wherein templates for the interactive menu or showing the collected information are ready-made, stored in a user terminal and being modified according to the parallel information.

6. The method of claim 1, wherein templates for the visual menu or for displaying of the compiled information are transmitted as parallel information.

7. The method of claim 1, wherein the information on the active users is collected by using an interactive menu on the screen of a user terminal comprising options to be selected and by using the parallel channel as a feedback channel for transmitting the user selections.

8. The method of claim 1, wherein the parallel information is transmitted as a packet transmission.

9. The method of claim 1, wherein location information on the audience is collected.

10. The method of claim 1, characterized by using wherein the collected information is used for searching for at least one of the good times, geographical areas and modes for advertising.

11. A media system for collecting information on the audience of a broadcast media stream, the media system comprising:
means for broadcasting a media stream on at least one broadcast channel of the broadcast system, the broadcast system being part of the media system,
means for transmitting parallel information on at least one parallel channel which parallel information is associated and synchronized with the media stream of at least one broadcasting channel using a radio telecommunication system of the media system,
means for connecting the audience to the media system as passive users or active users, the active users receiving the parallel information and the passive users not receiving the parallel information,
means for collecting information on the audience connected to the media system, the information relating to active users and passive users, and
means for processing the collected information in a predetermined way.

12. The system of claim 27, further comprising an interactive menu shown on the screen of a user terminal for connecting the audience via an interactive connection to the media stream system.

13. The media system of claim 27, further comprising means for collecting the information on the audience in a memory.

14. The media system of claim 27, further comprising means for showing the collected information on the screen of a user terminal and of a broadcaster's terminal.

15. The media system of claim 27, further comprising means for storing ready-made templates for the interactive menu or showing the collected information and modifying them according to the parallel information.

16. The media system of claim 27, further comprising means for transmitting the templates for the visual menu or showing the collected information as parallel information.

17. The media system of claim 27, further comprising means for collecting information on active users by using an interactive menu on the screen of a user terminal comprising options to be selected and by using the parallel channel as a feedback channel for transmitting the user selections.

18. The media system of claim 27, further comprising means for transmitting the parallel information as a packet transmission.

19. The media system of claim 27 further comprising means for collecting location information on the audience.

20. A user terminal for collecting information on an audience of a media stream broadcast by a media system the user terminal comprising:
means for receiving parallel information on at least one parallel channel which parallel information is associated and synchronized with the media stream of at least one broadcast channel of the broadcast system, the broadcast system being a part of the media system,
means for connecting the audience to the media system as passive users or active users, the active users receiving the parallel information and the passive users not receiving the parallel information,
means for changing a parallel information reception state according to the user's selections,
means for transmitting selections made by active users for collecting information on the audience connected to the media system, and
means for showing the collected information.

21. The user terminal of claim 20, further comprising means for the audience to have an interactive connection to the media stream system via an interactive menu.

22. The user terminal of claim 20, further comprising means for active users to make their selections by using a virtual menu on the screen of a user terminal comprising options to be selected.

23. The user terminal of claim 20, further comprising means for transmitting and receiving parallel information as a packet transmission.

24. The user terminal of claim 20, further comprising means for collecting information on active users by using an interactive menu on the screen of a user terminal comprising options to be selected and by using the parallel channel for transmitting the user selections.

25. A method for collecting information on an audience of a broadcast media stream, the method comprising:
connecting a radio telecommunication system and a broadcast system to perform a media system,
broadcasting a media stream on at least one broadcast channel of the broadcast system,
transmitting parallel information on at least one parallel channel which parallel information is associated and synchronized with the media stream of at least one broadcast channel,
connecting the audience to the media system as passive users or active users, the active users receiving the parallel information and the passive users not receiving the parallel information,
collecting information on the audience connected to the media system, the information being on active users or passive users, and
processing the collected information in a predetermined way.

26. The method of claim 1, wherein the collected information is shown on the screen of a user terminal or a broadcaster's terminal.

27. A media system for collecting information on the audience of a broadcast media stream, the media system comprising:
means for broadcasting a media stream on at least one broadcast channel of the broadcast system, the broadcast system being part of the media system,
means for transmitting parallel information on at least one parallel channel which parallel information is associated and synchronized with the media stream of at least one broadcasting channel using a radio telecommunication system of the media system,
means for connecting the audience to the media system as passive users or active users, the active users receiving the parallel information and the passive users not receiving the parallel information,
means for collecting information on the audience connected to the media system, the information relating to active users or passive users, and
means for processing the collected information in a predetermined way.

28. The media system of claim 27, further comprising means for showing the collected information on the screen of a user terminal or of a broadcaster's terminal.
